(19) United States
(12) Patent Application Publication
(10) Pub. No.: US 2013/0030877 A1
(43) Pub. Date: Jan. 31, 2013

(54) Interactive Navigation System to Selectively Decompose Quality of Service (QoS) Scores and QoS Ratings into Constituent Parts

(71) Applicants: Alberto Gutierrez, JR., Palo Alto, CA (US); Clarence Fredrick Ames, Belmont, CA (US); Jamil Husain, Bartlett, IL (US)

(72) Inventors: Alberto Gutierrez, JR., Palo Alto, CA (US); Clarence Fredrick Ames, Belmont, CA (US); Jamil Husain, Bartlett, IL (US)

(73) Assignee: CARRIER IQ, INC., MOUNTAIN VIEW, CA (US)

(21) Appl. No.: 13/536,952

(22) Filed: Aug. 19, 2012

Related U.S. Application Data
(63) Continuation of application No. 12/887,507, filed on Sep. 22, 2010.

(51) Int. Cl. G06Q 10/06

(52) U.S. Cl. 705/7.39

(57) ABSTRACT

An interactive method for operating a server to trace the origin of data which results in a display of unsatisfactory Quality of Service for a plurality of wireless communication devices.

### RELATED APPLICATIONS

The present application is a continuation in part of application Ser. No. 12887507 filed Sep. 22, 2010 and issued on ______ as U.S. Pat. No. ______ which is incorporated by reference in its entirety. A related patent application is ______ filed on ______, an other continuation in part of the same parent. Terminal disclaimers will be filed upon allowance of any two or more applications.

### BACKGROUND

Within the realm of communications systems, the accurate and reproducible measurement of Quality of Service is an important success factor. Quality of Service standards have been established for the Internet by the Internet Engineering Task Force, for CDMA based wireless networks by 3GPP2 for CDMA/ANSI-41 based networks, and for GSM and UTMS based technologies by the 3rd Generation Partnership Project (3GPP).

For example, the original scope of 3GPP was to produce Technical Specifications and Technical Reports for a 3G Mobile System based on evolved GSM core networks and the radio access technologies that they support (i.e., Universal Terrestrial Radio Access both Frequency Division and Time Division Duplex modes: FDD and TDD).

The scope was subsequently amended to include the maintenance and development of the GSM Technical Specifications and Technical Reports including evolved radio access technologies (e.g. General Packet Radio Service GPRS and Enhanced Data rates for GSM Evolution EDGE, HSPA, and LTE).

Yet standards committees by definition only endorse the least common denominator agreed to by all participants. And definitions are utilized to deliver agreed services using mechanisms and parameters. They do not necessary represent perceptions of the end user on service quality or performance. Furthermore, each service provider aspires to provide a total quality of service valued more highly by its customers over what a competitor offers. Thus each provider may have and keep confidential its proprietary measures, scores, and rating of what is superior, acceptable, and poor.

An example of how service providers may diverge in setting goals would be Key Performance Indicators applied to various Internet service classes. Even four KPIs applied to four service classes result in sixteen different measures of quality.

Consider that a service provider targeting multi-person game playing would seek a different blend than a consumer of entertainment in a moving vehicle. A good quality of service would include but not be limited to satisfying a set of network performance targets for KPIs appropriate for each service class.

However, merely satisfying the minimum acceptable level on only these KPI's may overlook other service aspects that are just as or even more important in determining the total quality experience of a type of customer.

Non-limiting exemplary aspects include, for a cellular or wireless domain, the ability to both make and hold a connection, battery life-time, quality-of-voice or image in intelligibility and recognition.

Definitions: KPI_DIMENSIONS and Key Performance Indicators

Within this patent application we define and use the term KPI_DIMENSION: KPI_DIMENSION is an independent variable over which any Key Performance Indicator (KPI) is calculated. KPI_DIMENSIONS defines the special dimensions and limits over which the KPI's will be calculated. A “measure” or “metric” can be considered a primitive parameter, for example such as “signal strength,” and “battery life.” A Key Performance Indicator(KPI) represents how these primitive measures are combined to ultimately indicate performance. Each KPI is a combination of primitive parameters which indicate performance. For example, “average” signal-strength could be a KPI comprising a mean or median of many individual instances of the primitive parameter signal-strength. This KPI (i.e., average) then would require the signal-strength to be sampled according to one or more selected “KPI_DIMENSION.”

One or more KPI_DIMENSION defines an N-dimensional space over which the KPIs are calculated. For example, each mobile directory number (MDN) in a set may be have reported its signal strength regularly into a data store. For a KPI-DIMENSION which is a range of time e.g. between 1 pm and 4 pm, there are 100,000 MDNs in the set so that there are 100,000 KPIs representing average-signal strength, one for each MDN, over the busiest hours, corresponding to this KPI_DIMENSION.

Thus it can be appreciated that what is needed is a method for each service provider to define for itself and measure how quality of service is delivered to their individual customers, efficiently assess the total quality of service experienced by millions of customers, identify reasons for poor performance by drilling into KPIs the specific measures which contribute to bad KPIs, identify the customers experiencing the problems, identify areas in their networks which need improvement, and efficiently process large amounts of data to identify which records need additional study and analysis.

### BRIEF DESCRIPTION OF DRAWINGS

FIG. 1 is a schematic of a network system.

FIGS. 2-6 are flowcharts of methods embodiments.

FIG. 7 is a block diagram of a server apparatus embodiment.

### SUMMARY OF THE INVENTION

The method comprises controlling a computer display device to present a plurality of Quality of Service Rating which are derived from underlying measures and analysis steps. The display further enables selection and navigation to the component KPIs and metrics which support the Quality of Service Rating. The Quality of Service Rating may be a visual, audio, sensory, graphical, textual, or numerical clue derived from comparing at least one threshold to a Quality of Service score. A total combined Quality of Service score is determined by adjusting from a gross score. The adjustments relate to corrections due to minor Key Performance Indicators. The gross score is determined from among the major Key Performance Indicators.

### DETAILED DISCLOSURE OF EMBODIMENTS

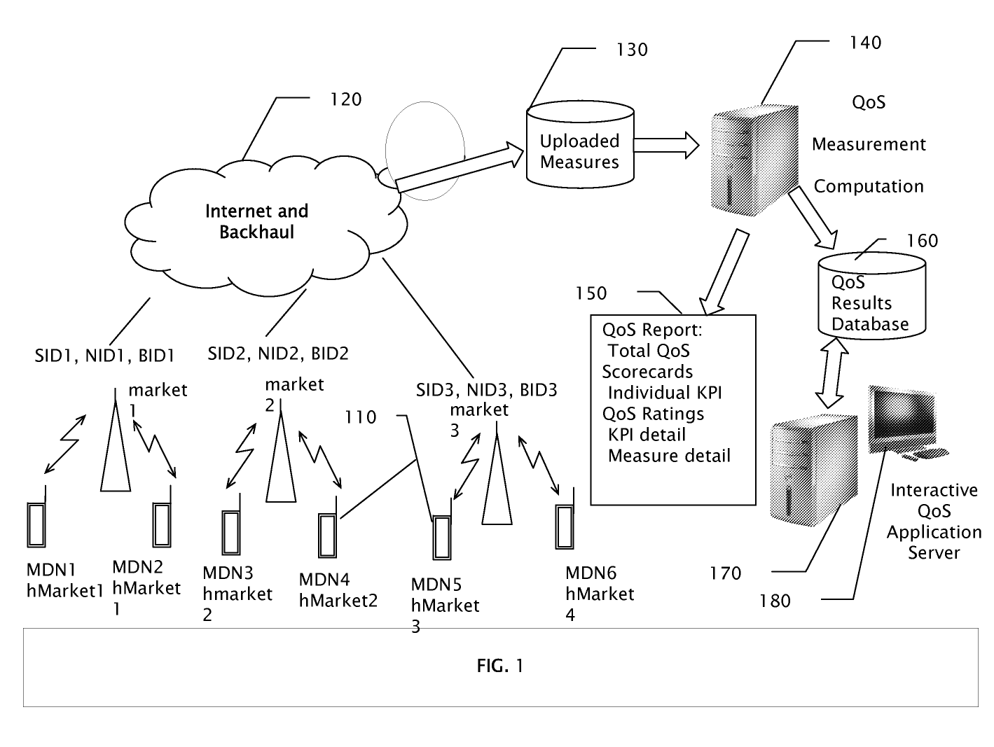

Referring now to FIG. 1, a schematic of a system in a network comprises a plurality of devices configured to collect metrics 110, communicatively coupled through an Internet and backhaul communications network 120, to a uploaded measures store 130, coupled to Quality of Service Measurement Computation Server 140, which writes to a Quality of Service Report Printer 150 and further writes to a computer readable disk file apparatus storing a Quality of Service Results Database 160, said database communicatively coupled to an Interactive Quality of Service Application Server 170 and to a Rating Display and Navigation System 180.

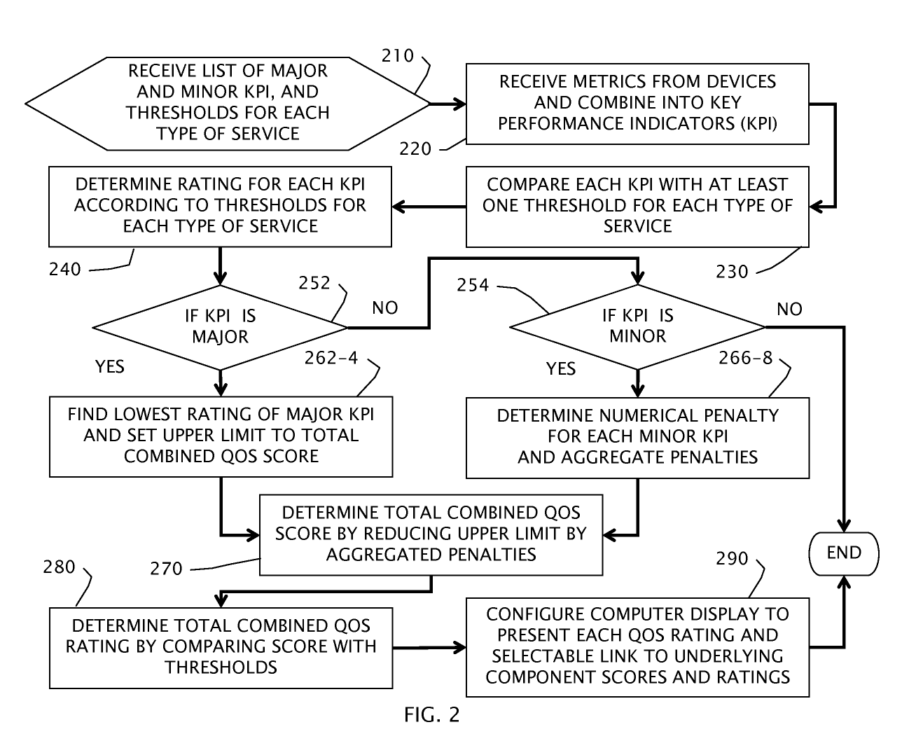

FIG. 2 is a flowchart of an embodiment of a method for controlling a display to present Quality of Service ratings derived from metrics received from devices. The method comprises at a server, receiving a list of major Key Performance Indicators and minor Key Performance Indicators (KPI), and a plurality of thresholds for each KPI for each type of service, and limits or ranges of one or more selected “KPI_DIMENSION” 210.

The method further comprises the step of receiving metrics from a plurality of devices and combining the metrics into Key Performance Indicators KPI 220.

The method further comprises comparing each KPI with at least one threshold for each type of service 230. Note that two distinct types of service may use the same KPI but have different thresholds for what is unsatisfactory. The method further comprises determining a rating for each KPI according to thresholds for each type of service 240. In an embodiment two thresholds divide up the range of KPI into three ratings. N thresholds can divide up the range into N+1 ratings.

In a first embodiment, the method further comprises the step of finding the lowest rating of major KPI 262 and setting the upper limit to a total combined Quality of Service Score to the lowest rating 264, when the KPI is identified as a major KPI 252.

In a first embodiment, the method further comprises the step of determining a numerical penalty for each minor KPI 266 and aggregating the penalties 268, when the KPI is minor 254. In an embodiment, if the KPI is neither major nor minor, it is not used at all in determining total Quality of Service(QoS).

In an embodiment, the numerical penalty for a minor KPI is zero if the minor KPI is of the highest possible rating. Depending on the comparison of the minor KPI with its thresholds the penalties may be small or larger.

In an embodiment a total combined Quality of Service Score is determined by reducing the upper limit of step 264 with the aggregated penalties of step 268 in method step 270. In a non-limiting exemplary case the upper limit is the least of the following <11000, 212, 98.6> and the aggregated penalties are the sum of <−0.1, −0.3, −0.7> with the total combined QoS score result of 97.5.

The method further comprises determining a total combined Quality of Service Rating by comparing a score with thresholds 280. In a non-limiting exemplary system a Rating of “Nice Personality” could be assigned to scores within the range of 85 to 135.

In an embodiment, the metrics received from the devices is transformed into control instructions to configure a computer display to present each Quality of Service rating and a selectable link to underlying component scores and ratings 290. That is, the computer display provides means for selecting an unsatisfactory rating to discover whether a major KPI or a minor KPI is responsible for the total combined QoS score, and further displaying the ratings of all the KPI making up the total score, and further selectively displaying the metrics which were combined into the one or more KPI's which cause the Total Combined QoS Rating to be below a threshold.

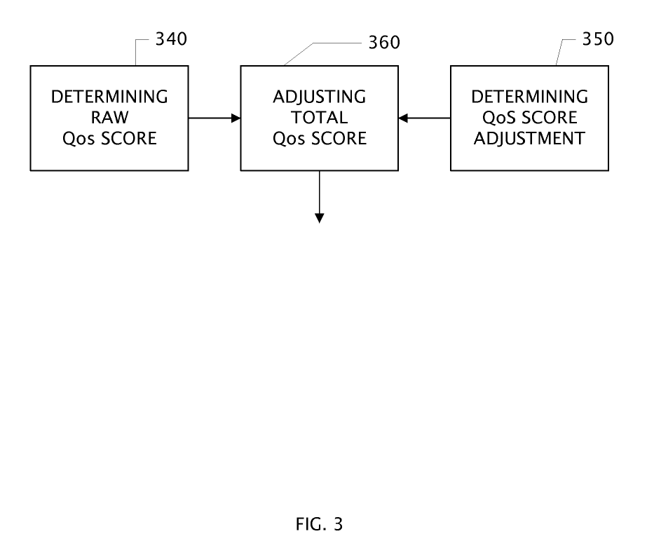

FIG. 3 is a flowchart of a method comprising [0028] determining a raw Quality of Service Score 340; [0029] determining a Quality of Service Score adjustment 350; and [0030] adjusting the Total Quality of Service Score 360.

In an embodiment, determining the raw Quality of Service Score comprises [0032] receiving a plurality of Key Performance Indicators assigned to bins, [0033] counting the number of Key Performance Indicators assigned to each bin, and [0034] computing a score based on the lowest bin having a non-zero number of Key Performance Indicators.

In an embodiment, determining the raw Quality of Service Score comprises [0036] receiving a plurality of Key Performance Indicators assigned to bins, [0037] counting the number of Key Performance Indicators assigned to each bin, [0038] computing a score based on the bin having a largest number of Key Performance Indicators.

In an embodiment, determining the raw Quality of Service Score comprises [0040] receiving a plurality of Key Performance Indicators assigned to bins, [0041] counting the number of Key Performance Indicators assigned to each bin, [0042] computing a score based on the lowest bin having a plurality of Key Performance Indicators.

In an embodiment, determining the raw Quality of Service Score comprises [0044] receiving a plurality of Key Performance Indicators assigned to bins, [0045] assigning a score equal to a value associated with the lowest bin which contains at least one Key Performance Indicator.

In an embodiment, determining a Quality of Service Score adjustment comprises [0047] receiving a plurality of Performance Indicators assigned to bins, [0048] applying a weight for each bin, [0049] summing the plurality of Performance Indicators weighted by the bins into which they were assigned, and [0050] normalizing the Quality of Service Score adjustment within a range.

In an embodiment the normalized Quality of Service adjustment is within the 0.9 and 0.0 range. In an embodiment the normalized Quality of Service adjustment is within the 0.99 and 0.00 range.

In an embodiment, adjusting the Total Quality of Service Score comprises adding the Raw Quality of Service Score to the Quality of Service adjustment.

In an embodiment, adjusting the Total Quality of Service Score comprises subtracting the Quality of Service adjustment from the Raw Quality of Service Score.

In an embodiment, if the Quality of Service Adjustment is significantly positive it can upwardly adjust the Raw Quality of Service Score.

In an embodiment, the Quality of Service Adjustment can only downwardly adjust the Raw Quality of Service Score unless the all of the Performance Indicators are near perfect.

In an embodiment, adjusting the Total Quality of Service Score comprises concatenating the Raw Quality of Service Score as more significant to the Quality of Service adjustment as less significant. In an embodiment more significant is understood to be left of the less significant. In an embodiment, a Raw QoS Score is expressed as a Roman or Arabic numeral. In an embodiment, a QoS Adjustment is expressed as a fraction or decimal number.

In an embodiment, the lowest Key Performance Indicator determines a ceiling for the Total Adjusted Score. In an embodiment, if only one Key Performance Indicator is lower than the rest it suggests an opportunity for improvement and can be shown in parenthesis as part of the QoS score. e.g. V(1).

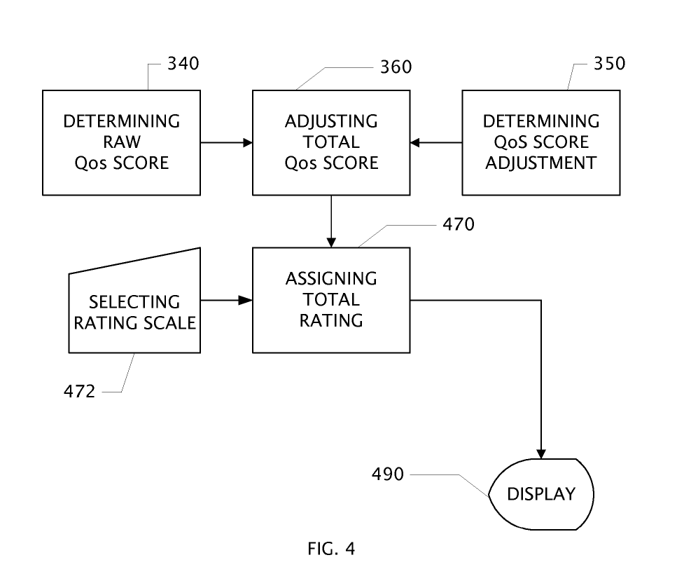

Referring now to FIG. 4, Quality of Service is more easily analyzed over large population if displayed visually as graphs, charts, colors, or descriptive ratings.

The method further comprises setting a rating scale to map Quality of Service Scores to Quality of Service Ratings 472, assigning a Total Rating to each Adjusted Total Quality of Service Score 470, and displaying on a computer device or printer, the ratings for each service 490.

In an embodiment, displaying comprises a stacked bar chart showing the relative percentage of each service in each rating.

In an embodiment, displaying comprises a plurality of pie charts showing the relative sizes of each served population and the portion enjoying each rating of QoS.

In an embodiment, displaying comprises showing a plurality of colored ikons representing service recipients which ikon if selected displays underlying scores and ratings which determined the adjusted total score.

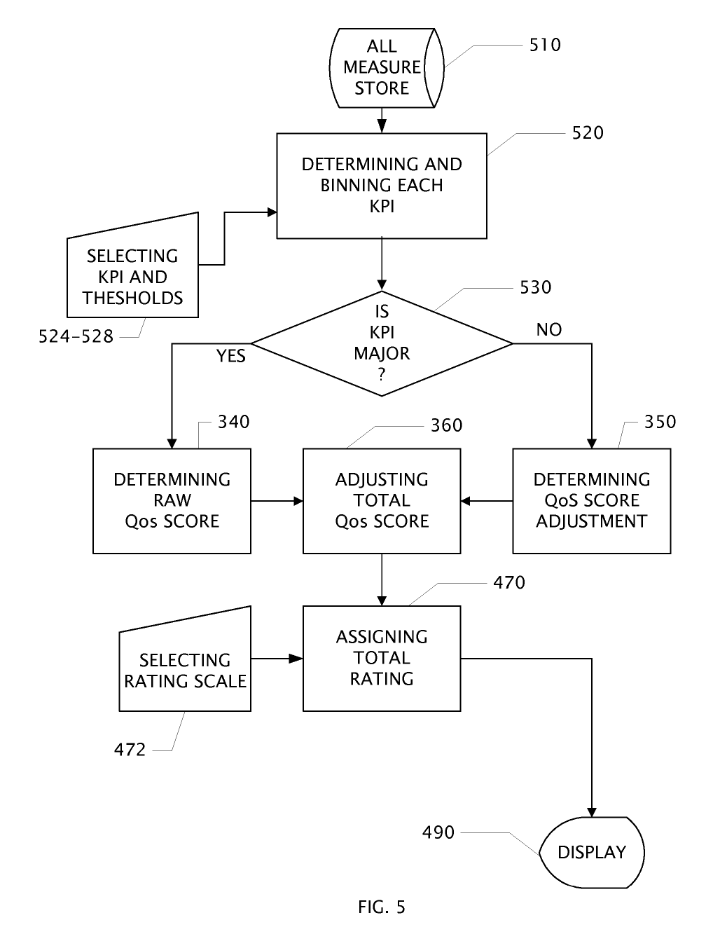

Referring now to FIG. 5, the method further comprises retrieving measures from an all measure store 510,

receiving the selected Key Performance Indicators (KPI) to compute 524 and at least one threshold for each KPI 526,

determining each selected KPI and assigned each KPI to a bin according to the threshold(s) wherein N thresholds determine N+1 bins 520.

The method further comprises receiving the designation that each KPI is major or not major 528 and transferring each KPI to the process of determining a raw QoS score when the KPI is major and transferring each KPI to the process of determining QoS Score Adjustment when the KPI is non-major 530.

It is understood that the methods of computing each KPI are intended to be stable even though new KPI may be defined for new purposes. However a specific KPI may be major for one service and not major for another, and yet even not useful at all for measuring quality of service for some service type. Similarly the bins for KPI may not be the same in all services so the thresholds used to bin each KPI may be selectable for various services.

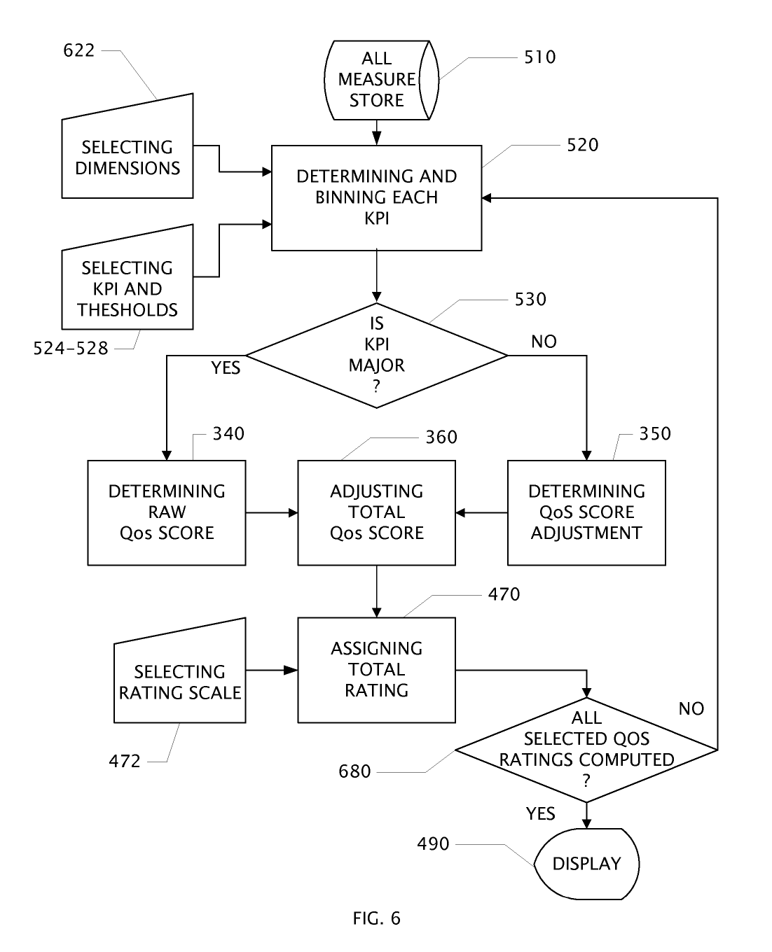

Referring now to FIG. 6, to better understand the causes of variations in quality of service, it is desirable to select dimensions on which to vary the measures of the services to be scored. The method further comprises selecting dimensions 622 to control which of the all measure store is accessed as part of determining and binning each KPI, and continuing the process until all selected QoS ratings have been computed 680.

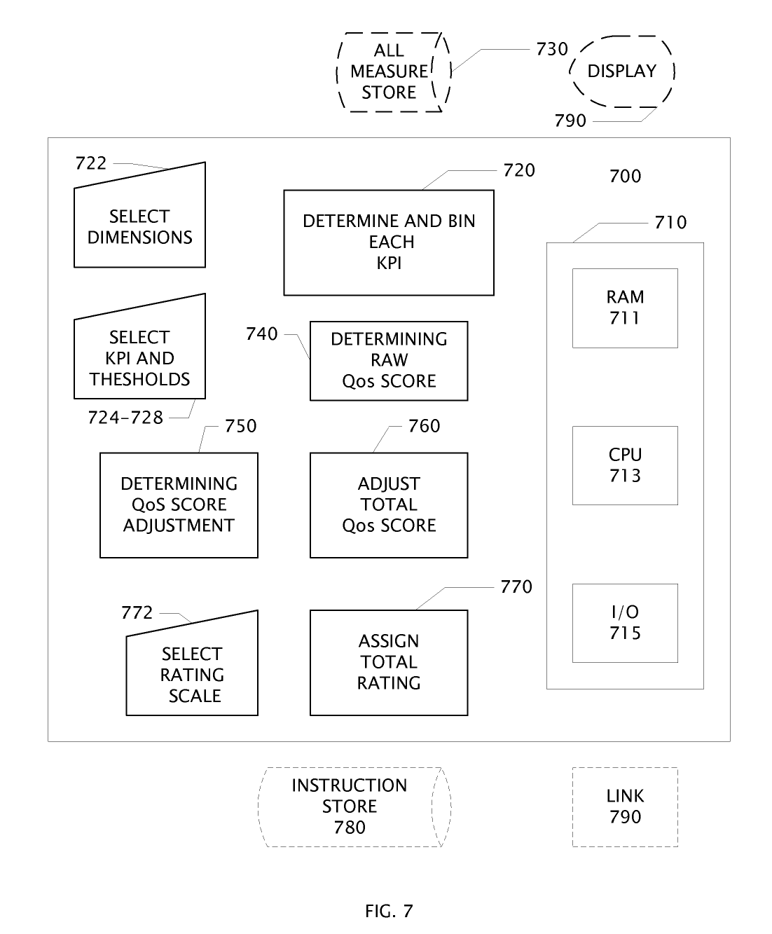

Referring now to FIG. 7 a system embodiment of the invention comprises an apparatus 700 communicatively coupled to an all measure store 730 and to a display 790. The apparatus is further coupled to a link interface 790 and to an instruction store 780. The apparatus comprises a processor 710 which is configured by the instruction store to perform transformative operations of the claimed methods. The processor 710 comprises random access memory 711, a central processing unit 713 configured by the instructions of the instruction store, and an input output control unit 715 for receiving and transmitting data and instructions. The apparatus further comprises a circuit to determine and bin each key performance indicator 720, a circuit to determine a raw score 740, a circuit to determine a Quality of Service score adjustment 750, and a circuit to adjust the total quality of service score 760. In an embodiment, the circuit to determine and bin each KPI is coupled to a circuit to select dimensions 722. In an embodiment, the circuit to determine and bin each KPI is coupled to a circuit to select KPI and thresholds 724 and 728. In an embodiment, the circuit to adjust the total score is coupled to a circuit to assign a total score rating 770. In an embodiment, the circuit to assign a total score rating is coupled to a circuit to select a rating scale. It is known in the art that circuits may be emulated by a processor configured by instructions.

An apparatus embodiment comprises a processor comprised of RAM, CPU, and I/Q configured by a communicatively coupled instruction store to display a total QoS rating derived by a circuit to assign a total rating coupled to a circuit to select a rating scale and to a circuit to adjust a total QoS score.

In an embodiment the apparatus further comprises a circuit to determine a raw QoS score, a circuit to determine a QoS Score adjustment, a circuit to determine and bin each major and each minor KPI, and a circuit to select major KPI, thresholds, and dimensions.

A software program product embodiment comprises instructions encoded on a computer-readable storage device to configure a processor to execute the computer method to adjust a total QoS score by determining a raw QoS score from the lowest of a plurality of major KPI and subtract a QoS score adjustment by weighting, adding, and normalizing minor KPI scores.

In an embodiment the software program product further comprises instructions to control a display of Quality of Service scores by applying rating scales and to determine QoS scores by applying thresholds to selected KPI over selected dimensions.

A system embodiment comprises means for determining and binning key performance indicators, means for determining a raw QoS score and a QoS score adjustment, means for adjusting a total QoS score and assigning a total QoS rating.

In an embodiment the system further comprises means for displaying a total QoS score rating, means for selecting dimensions, KPI, thresholds, and rating scales, and means for navigating to view component KPI and scores from which the rating is derived.

A non-limiting exemplary alternate embodiment of the invention is disclosed below.

A process of drilling-down comprises selection and highlighting of a selected rating initiating operative display of the combined score and the threshold and the components of the score in an interactive manner is useful in order to find the source of a quality problem. For example, in the case when the KPI_DIMENSIONS are MDN and Busy-Hour, and there are 100,000 MDNs in the set. After displaying the resulting QoS ratings for each MDN, there may be some MDNs with a less than acceptable QoS rating. In order to gain better visibility as to the source of the less than acceptable QoS ratings, means are provided to re-define the KPI_DIMENSIONS, to re-compute the KPIs corresponding to these new KPI_DIMENSIONs, and to compute a new set of QoS ratings and scores corresponding to these new KPI_DMENSIONS. Suppose that 100 MDNs from the total set of 100,000 show poor average signal quality. The embodiment provides means for adding a KPI_DIMENSION to the set, in a non-limiting example: base-station identification. After re-computing the KPIs and QoS ratings corresponding to this new dimension, the embodiment provides means for displaying 50,000 KPI scores, corresponding to 100 base stations, corresponding to 10,000 MDNs that associate with those base stations over the busy hour, where each MDN is associated with 5 base stations over the busy hour. In this case the embodiment provides means for displaying for each MDN, a QoS score and rating corresponding to each of 5 base stations. Continuing with the example, the embodiment provides means for determining that the poor QoS score and rating occurs for one of the 5 base stations. Accordingly, the embodiment provides means for interactively redefining the KPI_DIMENSIONs, in a closed loop system, after reviewing an initial QoS result, and determining more precisely the source of the problem whereby the QoS system is superior to conventional systems for debugging quality issues. It is now apparent why defining the KPI_DIMENSION in a closed loop manner is important to the QoS system.

In an embodiment, controlling a display to show a QoS rating provides a means to link to key performance indicators that are responsible for said QoS rating. The problem devices, their locations, configurations, and measured parameters are displayable from selection of the resultant QoS rating display.

In one preferred embodiment, determining the minimum score among all the major KPI provides a first component (gross score) of the total score. This first component is reduced for each minor KPI that is less than the highest score. That is, if the score of all the minor KPI are “excellent” meeting the highest threshold of quality, then there is no penalty and the lowest major KPI determines the total QoS rating.

Service Performance at the mobile device is determined for at least one service type by a computer-implemented method of distilling KPIs into a single score and rating. For the purpose of this patent application, Ratings are defined as a subjective description of a score relative to one or more thresholds. A rating may be Pass or Fail based on a single threshold. For the purpose of this patent application Scores are defined as numerical values which can be averaged, normalized, summed, weighted, multiplied, and otherwise arithmetically and statistically manipulated.

For each type of service, major KPIs are selected which dominate a combined score by receiving user selections, a table, or computer readable file. Program steps configure a processor to determine when all of the selected major KPIs meet or exceed a threshold in order for the combined score to attain that threshold. In an embodiment, major KPIs are combined in a multi-value analog AND operation, whereby a score (i.e., value) above the common part achieved by any KPI is chopped off because it does not correspond to the other KPIs. The worst performance of all the major KPI sets the limit. Different types of service may be defined in a computer-readable input table to have various thresholds for any one KPI and not have the same number or types of KPI included.

A Quality of Service Rating is determined by comparing a combined Quality of Service Score with at least one numerical threshold. It is understood that ratings are descriptive words or symbols and may be text strings, colors, smells, symbols, icons, sounds, equivalent to changing the tangible transformation of data to sensory representation. Selecting, highlighting, or drilling-down into a selected rating displays the combined score and the threshold and the components of the score.

In an embodiment the reduction for each non-excellent rating is normalized. In an embodiment, the reduction for each non-excellent rating is scaled where scaled means if there are several non-excellent ratings of decreasing desirability, the reduction is greater for lower desirability rating.

Each element of a summary display is hyper linked to its underlying data or equation. This allows drilling into a problem area to determine the significant contributing causes.

The method includes the steps of receiving a plurality of threshold and related ratings, comparing each KPI score with the thresholds and assigning the related KPI rating. Logically N thresholds result in N+1 ratings.

An embodiment of the invention is a system comprising software and apparatus configured by the software to transform a plurality of stored data packages into an array or matrix of Quality of Service Scores or Quality of Service Ratings and display a correlation of the change in Score or Rating with changes in one or more dimensions of the array or matrix. E.g. Is there a hot spot or cold spot for Quality in the dimension of location, software configuration, number of antennae, altitude of base or of wireless communication device or radio frequency chipset?

Consider that subset can be defined to occupy cells of an n-dimensional matrix or hypercube. The Quality of Service of each cell may viewed from any of the n-dimensions to determine if there is a correlation in the Quality of Service Score and travel along one of the dimensions and to identify areas or points in the n-dimensional hyperspace where QoS performance is within a range to warrant further interest, and thereby provide means for identifying underlying KPIs and one or more specific measurement which are responsible (i.e., causality) for the resulting QoS score of interest.

The apparatus receives and transforms data packages into Scores and Ratings and display them on a computer-configured display and selection apparatus:

A. the apparatus provides display and selection means to categorize and arrange data packages into subgroups having a real or hypothetical similarity and order.

B. the apparatus comprises a processor which determines a quality of service score for each subgroup; and

C. the apparatus has display circuits which present the values for comparison of one cell to others in adjacent coordinates and along a selected dimension, and

D. further comprises control circuits to combine or remove packages of data or reorganize them according to new selections, combinations, or eliminations and to reinitiate determination of Quality of Service scores.

An embodiment of the invention is a computer-method to transform samples of data from a plurality of wireless communication apparatus which are configured to record data according to a collection profile. The method includes reading from a data storage device files which include non-dynamic characteristics such as configuration, and unique identifiers along with quality of service measurements taken at certain times, certain locations, and certain environmental conditions including the radio channel.

The method comprises:

e. Identifying at least two subsets, corresponding to groups of measurements, distinguished according to at least a first characteristic. These subsets are chosen according to a dimension (i.e., characteristic) over which a Quality of Service (QoS) score is to be computed. As a non-limiting example, a dimension could correspond to geographical points such as cellular tower locations, corresponding to each measurement. Thus, correspondingly each point, which is an element in the dimension, is associated with a subset of corresponding measurements. In one embodiment, a dimension is defined on any measurement characteristic or Key Performance Indicator (KPI) derived from a measurement characteristic and furthermore a plurality of such dimensions can be chosen. In an embodiment, a dimension is a combination of measurement characteristics and referential data.

f. Computing a QoS score for each subset of measurements corresponding to the chosen dimensional set. Computing a QoS score is comprised of the following. Computing at least one KPI from a measurement characteristic and determining a QoS score based on at least one threshold.

g. Determining and displaying a QoS score for each subset in the dimensional set which enables correlation and confidence level between changes in Quality of Service Score for a first subset and a second subset and changes in a characteristic or a measurement that distinguishes the first subset from the second subset.

h. Providing by configuring a processor communicatively coupled to a display, selection, and input apparatus: menus, checkboxes, sliders, text entry forms to receive a selection of measurement characteristics, QoS thresholds, KPI definitions and in addition to define at least one Dimension resulting in at least two subsets of the plurality of wireless communication apparatus.

i. Providing graphical or formulaic entry control by configuring a processor communicatively coupled to a display, selection, and input apparatus to express a determination method for a Quality of Service Score. Providing a computer-implemented user interface to receive a set of ranges or limits, comparisons, and selection of characteristics for selecting subsets and for determining a Quality of Service Rating.

In an embodiment, a Quality of Service score is determined for each of a plurality of subsets.

The method comprises

j. reading stored data packages recorded at a plurality of wireless communication devices according to a collection profile,

wherein data packages comprise unique identifiers and characteristics and recorded transitory data;

k. providing a selection control panel on a computer display by configuring a processor through which characteristics may be scoped, limited, aggregated, or categorized;

l. receiving selection of at least one dimension and at least one range or limit with which data packages can be organized into subsets,

m. determining a Quality of Service Score for each subset;

n. when a Quality of Service Score is substantially disparate among a plurality of subset, determining a correlation with plausible causality between variations in Quality of Service and the independent characteristics.

In an embodiment, the method comprises the following steps;

step o. Reading m packages of metrics which may be located in an n dimensional space,

step p. receiving a range of values in at least one dimension and selecting metrics which are bounded by the dimension and range of values,

step q. computing at least one Key Performance Indicator from the selected metrics,

step r. receiving at least p limits for each Key Performance

Indicator and assigning each KPI into one of p+1 bins,

step s. determining a ceiling for a total quality of service value if a KPI is major,

step t. determining an adjustment for a quality of service value if a KPI is minor,

step w. applying one or more adjustments to the lowest ceiling of quality of service values,

step x. grading an adjusted total quality of service value according to a scale.

In one embodiment, the invention comprises a method comprising

determining KPI scores for at least one selected dimension of measures; [0119] categorizing KPI into collective KPI and Adjustive KPI and assigning them into bins based on scores; and [0120] combining KPI into a total quality of service rating.

In an embodiment, determining KPI scores for at least one selected dimension of measures [0122] receiving a list of pertinent KPI to compute, [0123] receiving a list of selected dimensions to analyze, [0124] retrieving the measures which are bounded by the selected dimensions, and [0125] computing each pertinent KPI across the selected dimension.

In an embodiment, categorizing KPI into collective KPI and adjustive KPI and assigning them into bins based on scores comprises

receiving ranges or limits to determine bins for each KPI, [0128] receiving flags to determine the collective KPI and the adjustive KPI,

determining the lowest bin populated by a collective KPI, and [0130] determining a bin for each adjustive KPI.

In an embodiment, combining KPI into a total quality of service rating comprises [0132] receiving adjustive weights for each adjustive KPI and receiving a total quality of service scale, [0133] determining an adjustment by weighting the adjustive KPI by their Adjustive weights, [0134] determining an adjusted total quality of service score by applying the adjustments to the lowest ceiling of the collective Key Performance Indicator, and [0135] determining a total quality of service rating by applying the scale to the total quality of service score.

In an other embodiment, Quality of Service is compared on different dimensions. In an other embodiment, Interactive analysis provides a way to interactively drill down to discover the dominant constituent part contributing to a Quality of Service rating or score.

In an embodiment of the present invention, measures recorded at a plurality of wireless communication devices are transformed into Key Performance Indicators (KPIs). Each KPI is normalized, that is transformed to a common scale shared by all KPIs. For each type of service, a KPI is categorized as a Major KPI or a Minor KPI, (or not used at all).

In an embodiment, each KPI which is numerical is transformed into a rating which is non-numerical. In an embodiment a rating is formulated from a normalized KPI. In an other embodiment, a rating is formulated from a non-normalized KPI. Examples of Ratings are non-numerical labels, such as Good, Bad, and Ugly.

In an embodiment a Composite QoS numerical score is generated for each service type by treating Major KPI differently than Minor KPI as disclosed and claimed in the parent patent application. In an embodiment an intermediate score is determined from the Major KPI of a service. This intermediate score is then adjusted by a combination (linear or non-linear) of the minor KPIs of that service. In an embodiment the major KPI are combined by taking the least, poorest, worst, or minimum of the Majors as the dominating score. As an illustration, Thinness could be determined by taking the minimum value of the set height, width, length.

In an embodiment, the Composite QoS score which results from the intermediate score being adjusted by the combination of Minor KPI is transformed to a non-numerical Composite QoS Rating. N-1 score thresholds determine N Ratings.

In an embodiment a selectable dimension is selected. At each position in the selectable dimension, the method computes the Composite QoS score and Rating. By computing the Composite QoS score at each increment of the selectable dimension, the method obtains local maxima or local minima at certain coordinates.

In order to provide interactive discovery of troublesome phenomena, Composite QoS Rating and Scores are displayed as hyperlinks in an electronic document. By selectively navigating through the hyperlinks, a user may cause new computation of intermediate QoS scores and ratings. A user may select new selected dimensions to decompose into constituent scores and ratings. The selectable decomposition into constituent parts may reveal the cause of an unsatisfactory Composite Rating.

One embodiment of the invention is a batch program controlling a server apparatus to transform data metrics recorded at a plurality of wireless communication devices into a plurality of non-numerical Quality of Service(QoS) Ratings across selected dimensions, the method embodied in computer executable instructions encoded in non-transitory media to control a processor:

receiving a plurality of independent dimensions specified in a computer readable file encoded in non-transitory media,

retrieving data metrics recorded at a plurality of wireless devices,

binning the retrieved data metrics according to at least one of the independent dimensions,

determining a non-numerical QoS rating for each bin by transforming the data metrics recorded at the plurality of wireless devices categorized by the independent dimensions, and

storing into non-transitory computer readable media a graphical or tabular output report which arranges the QoS rating for each bin of data according to at least one of the independent dimensions;

the determining a non-numerical QoS rating comprising,

configuring a processor to compute a numerical QoS score for each bin, by:

receiving at least one threshold for each Key Performance Indicator(KPI) for each type of service,

determining a numerical score for each KPI based on data metrics received,

determining whether each KPI is major or minor for each type of service,

determining a non-numerical KPI rating for each score of each KPI according to the inequality of the value of the KPI score compared to the at least one threshold,

determining a numerical adjustment value by combining the non-numerical ratings of each minor KPI within each bin,

determining a gross numerical score for each bin by consideration of a minimum among a plurality of major KPI non-numerical ratings within each bin,

determining an adjusted gross numerical score by arithmetically applying the numerical adjustment value to the gross numerical scores,

determining a non-numerical rating for each bin by comparing an other threshold to each adjusted gross numerical score,

wherein at least one of the plurality of independent dimensions is a nominal category. Nominal categories can be tradenames, models, firmware revisions, carriers, communication standards, or colors. Are Orange wireless devices “juicier” than Blueberry wireless devices? Juicy-ness can be illustrated in a bar chart.

In an improved embodiment, within each bin of retrieved data metrics grouped according to a first independent dimension, the method further

sub-bins the binned data metrics according to at least one second independent dimension; and

determines a non-numerical QoS rating for each sub-bin,

wherein the graphical or tabular output report arranges the non-numerical QoS rating for each sub-bin within a two-dimensional table or chart; and
wherein a second one of the plurality of independent dimensions is a numerical measurement and sub-bins are determined by inequality thresholds against at least one numerical value. An example of this could be ranges of latitude and longitude for cellular base stations and the Quality of Service type could be the probability of dropped calls.

In an other embodiment, each sub-bin determined by the second independent dimension is further sub-binned by another independent dimension, the graphical or tabular output report additionally presents the non-numerical QoS rating for each sub-bin as an array of two-dimensional maps, graphs, tables or charts; and a third one of the plurality of independent dimensions is an other numerical measurement.

In an other embodiment, the Quality of Service ratings are represented as variable sizes, colors, patterns, or symbols for each bin, and for each sub-bin.

An other aspect of the invention is an interactive method for operation of an apparatus comprising a processor coupled to a computer readable instruction store and a computer readable data store, the processor further coupled to a display apparatus, the method configures the processor by instructions to configure the display apparatus to traverse a hierarchy of stored Quality of Service Ratings, scores, and measurements recorded by a plurality of wireless communication devices:

displaying a plurality of selectable Quality of Service(QoS) Ratings on a display apparatus communicatively coupled to a processor;

receiving a selection of one of the plurality of selectable Quality of Service Ratings; and

displaying a plurality of selectable major Key Performance Indicator(KPI) ratings on a display apparatus communicatively coupled to the processor.

In an embodiment, receiving a selection of one of the plurality of selectable QoS rating further comprises:

retrieving from a computer-readable non-transitory media a plurality of measurements which were transformed into the selected Quality of Service Rating;

transforming the measurements into each Key Performance Indicator (KPI) numerical score related to the selected Quality of Service Rating:

normalizing each KPI numerical score to a common scale shared by all KPIs;

determining if each KPI is a major KPI or a minor KPI for a type of service;

determining a rating for each major KPI by comparing at least one inequality threshold to the normalized KPI numerical score.

In an embodiment, the method has additional steps:

receiving a selection of one of the displayed major KPI ratings,

displaying at least one inequality threshold for the selected major KPI rating,

displaying a numerical KPI score for the selected major KPI rating, and

displaying the plurality of measurements which were transformed into the numerical score related to the selected KPI rating.

In an improved embodiment, the method continues by

displaying a plurality of selectable minor KPI ratings related to a selected QoS rating on a display,

receiving a selection of a minor KPI rating,

displaying a numerical adjustment value applied to the gross numerical QoS score resulting from the minor KPI rating, and

displaying the data metrics recorded at a plurality of wireless communication devices which were transformed into a numerical KPI score of the selected minor KPI rating.

### CONCLUSION

We distinguish the invention by providing multidimensional analysis of the KPIs which may correlate with either satisfactory or unsatisfactory Quality of Service Ratings. We distinguish the invention by providing interactive drilling down to reveal the major and minor KPI which determine an inferior Quality of Service rating. The present invention may be easily distinguished from previously presented non-linear combination of major Key Performance Indicators with a weighted combination of non-major Key Performance Indicators, wherein the adjustment is subtracted from the gross score and wherein the gross score reflects the lowest i.e. least desirable bin of the major Key Performance Indicators relative to their respective thresholds.

The present invention is further distinguished by providing means for receiving and recategorizing stored data into subsets according to multiple dimensions and limits or ranges in each dimension and determining and displaying Quality of Service scores and ratings in each dimension and correlating changes in Quality of Service with changes in data recorded at wireless communication apparatus in the same dimension. It is particularly pointed out that the dimensions are defined and selected after the data is stored.

As indicated herein, embodiments of the present invention may be implemented in connection with a special purpose or general purpose telecommunications device, including wireless and wireline telephones, other wireless communication devices, or special purpose or general purpose computers that are adapted to have comparable telecommunications capabilities. Embodiments within the scope of the present invention also include computer-readable stores for having computer-executable instructions or electronic content structures stored thereon, and these terms are defined to extend to any such tangible media devices that are used with telecommunications devices.

By way of example such computer-readable media can comprise RAM, ROM, flash memory, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

Computer-executable instructions comprise, for example, instructions and content which cause a general purpose computer, special purpose computer, special purpose processing device or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

We claim:

1. An interactive method for operation of an apparatus comprising a processor coupled to a computer readable instruction store and a computer readable data store, the processor further coupled to a display apparatus, the method configures the processor by instructions to configure the display apparatus to traverse a hierarchy of stored Quality of Service Ratings, scores, and measures recorded by a plurality of wireless communication devices:
displaying a plurality of selectable Quality of Service(QoS) Ratings on the display apparatus communicatively coupled to a processor;
receiving a selection of one of the plurality of selectable Quality of Service Ratings; and
displaying a plurality of selectable major Key Performance Indicator(KPI) ratings on the display apparatus communicatively coupled to the processor.

2. The method of claim 1 wherein receiving a selection of one of the plurality of selectable QoS rating further comprises:
retrieving from a computer-readable non-transitory media a plurality of measures which were transformed into the selected Quality of Service Rating;
transforming the measures into each Key Performance Indicator (KPI) numerical score related to the selected Quality of Service Rating:
normalizing each KPI numerical score to a common scale shared by all KPI's;
determining if each KPI is a major KPI or a minor KPI for a type of service;
determining a rating for each major KPI by comparing at least one inequality threshold to the normalized KPI numerical score.

3. The method of claim 1 further comprising
receiving a selection of one of the displayed major KPI ratings,
displaying at least one inequality threshold for the selected major KPI rating,
displaying a numerical KPI score for the selected major KPI rating,
displaying the plurality of measures which were transformed into the numerical score related to the selected KPI rating,

4. The method of claim 1 further comprising
displaying a plurality of selectable minor KPI ratings related to a selected QoS rating on the display,
receiving a selection of a minor KPI rating,
displaying a numerical adjustment value applied to the gross numerical QoS score resulting from the minor KPI rating, and
displaying the measures recorded at a plurality of wireless communication devices which were transformed into a numerical KPI score of the selected minor KPI rating.

5. An apparatus configured to categorize and arrange stored data packages into subgroups having a real or hypothetical similarity and order,
a processor which determines a quality of service score for each subgroup;
display circuits which present values for comparison of one subgroup to others in adjacent coordinates and along a selected dimension,
control circuits to combine or remove packages of data or reorganize them according to new selections, combinations, or eliminations and to reinitiate determination of Quality of Service scores.

6. The apparatus of claim 5 configured for drilling-down into Quality of Service Ratings comprises
means for selection and highlighting of a selected rating which initiates operative display of the combined score and the threshold and the components of the score in an interactive manner,
means for display of the resulting QoS ratings for each user terminal,
means for re-defining the KPI_{—} DIMENSIONS, for re-computing the KPIs corresponding to these new KPI_DIMENSIONs, and for computing a new set of QoS ratings and scores corresponding to these new KPI_DMENSIONS;
means for adding a KPI_DIMENSION to the set,
means for displaying KPI scores,
means for determining where the poor QoS score and rating originates,
means for interactively redefining the KPI_DIMENSIONs, in a closed loop system, after reviewing an initial QoS result, and determining the origin of the score.

7. The apparatus of claim 5 comprising a processor comprised of
RAM,
CPU, and
input/output circuits, configured by a communicatively coupled instruction store to display a total QoS rating derived by a circuit to assign a total rating coupled to a circuit to select a rating scale and to a circuit to adjust a total QoS score, and a circuit to determine a raw QoS score, a circuit to determine a QoS Score adjustment, a circuit to determine and bin each major and each minor KPI, and a circuit to select major KPI, thresholds, and dimensions.

8. A software program product tangibly embodied as instructions encoded on a computer-readable storage device to configure a processor to execute a computer method
to adjust a total QoS score by determining a raw QoS score from the lowest of a plurality of major KPI and
subtract a QoS score adjustment by weighting, adding, and normalizing minor KPI scores; and instructions
to apply rating scales and
to determine QoS scores by applying thresholds to selected KPI over selected dimensions.

9. A system comprising:
means for determining and binning key performance indicators(KPI),
means for determining a raw Quality of Service (QoS) score and a QoS score adjustment,
means for adjusting a total QoS score and assigning a total QoS rating,
means for displaying a total QoS score rating,
means for selecting dimensions, KPI, thresholds, and rating scales, and means for navigating to view component KPI and scores from which the rating is derived.
